(19) United States
(12) Patent Application Publication
(10) Pub. No.: US 2006/0179321 A1
(43) Pub. Date: Aug. 10, 2006

(54) Method and system of applying user permissions to an application program environment

(76) Inventors: Nigel Dawson, Garran (AU); Shane Mortensen, Scullin (AU); Mark Glasgow, O'Connor (AU)

Correspondence Address: BAKER BOTTS L.L.P., 2001 ROSS AVENUE, SUITE 600, DALLAS, TX, 75201-2980, US

(21) Appl. No.: 11/053,314

(22) Filed: Feb. 7, 2005

(51) Int. Cl. H04L 9/00

(52) U.S. Cl. 713/182

(57) ABSTRACT

An embodiment of the invention relates to a method and system of applying a user's permission status to an entire application program environment comprising: parsing the entire application program to determine a description of user permission requirements for individual functions, and providing a respective descriptive document. A schema is then produced that models a class structure of the description of user permission requirements based on the descriptive document. The user permissions are applied in accordance with the results of a comparison of a predetermined user's permission and the permission requirements in the class structure.

### TECHNICAL FIELD OF THE INVENTION

The present invention relates to an application program environment. More particularly, it concerns a system and method that allows a user's permission status to be applied to the entire application program.

### BACKGROUND OF THE INVENTION

Application program environments, such as those consisting of menus and toolbars, require the user to have the appropriate permission to access certain functions provided by each of said menus and toolbars.

User permissions are stored on a database, and access to a certain function is determined by a system administrator. In order for a user to access a certain function, the system administrator must check the database to ensure that the user has the appropriate permission, then assign the user to the function by the laborious task of accessing the user permission requirements of the function and individually assigning the right to access the function to the user. This, of course, is not achieved in real-time.

A problem occurs in this situation when individual user's permissions change in the database. The system administrator needs to be informed of this change and is required to re-access the function's permission requirements to adjust for the individual user accordingly. Again, this task is not undertaken in real-time, and is quite time consuming.

Users may be classified into groups with the same permissions, saving the system administrator from accessing individual user's permissions to assign their accessibility to a certain function. However, when entities have a large number of groups, the abovementioned problems of time consuming changes occur. Additionally, if one user's permissions change, they can no longer be categorised in such a group and must be processed separately, delaying the user's access.

Another method employed to determine user access is saving the permission requirements of a certain function in a user interface library. The user's access is determined by a comparison of the user's permissions requirements with the user's permission status on the database. This method results in a large number of libraries being established for the system administrator to monitor. Any changes to the library need to be attended to individually, costing the administrator a significant amount of time. Additionally, the format requirement for each function in a library varies, leaving the administrator with commonality problems even before the user's access is determined.

### SUMMARY OF THE INVENTION

It is therefore desirable to have a method and system to simplify the process of determining user access to multiple functions within an application program environment.

According to an embodiment of the invention, a method and system includes parsing the entire application program to determine a description of user permission requirements for individual functions, and providing a respective descriptive document. A schema is then produced that models a class structure of the description of user permission requirements based on the descriptive document. User access is determined by a comparison of a predetermined user's permission and the permission requirements in the class structure.

Certain embodiments of the present invention may provide various technical advantages. For example, an embodiment may provide an improved method and system for determining user access to an application program environment which addresses the above drawbacks and/or provides enhanced functionality.

Although specific advantages have been enumerated above, various embodiments may include all, some, or none of the enumerated advantages. Additionally, other advantages may become readily apparent to one of ordinary skill in the art after review of the following figures and description.

### BRIEF DESCRIPTION OF THE DRAWINGS

The invention will now be described in a non-limiting manner with respect to a preferred embodiment in which:

FIG. 1 is a block diagram of a typical user access system;

FIG. 2 is a block diagram of an embodiment of the invention; and

FIGS. 3A 3B, and 3C depict an embodiment of the invention in a real-life application.

### DETAILED DESCRIPTION OF EXAMPLE EMBODIMENTS OF THE INVENTION

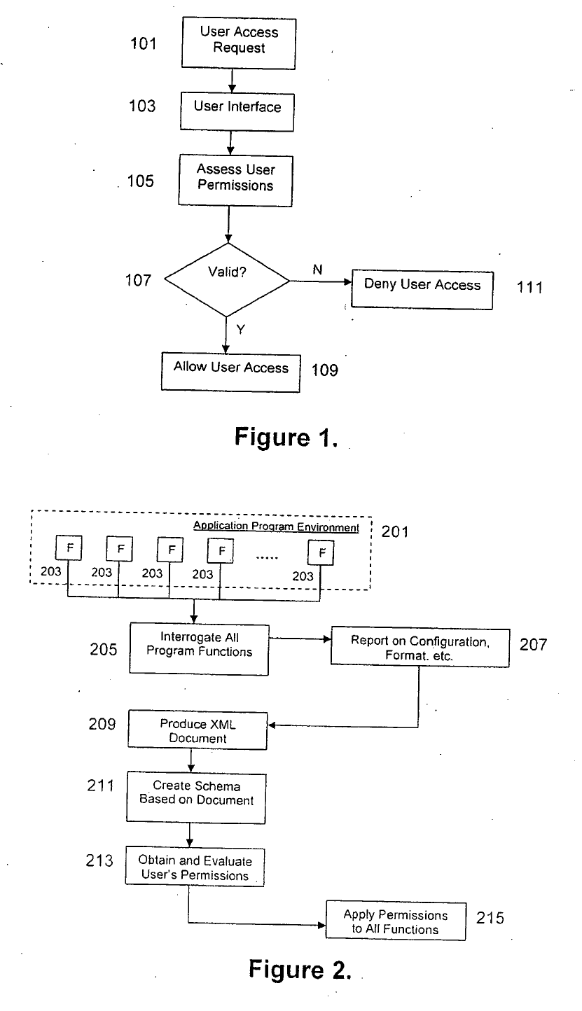

FIG. 1 is a block diagram depicting an overview of a typical system for determining user access to a program via an interface based on user permissions.

The user requests access 101 to a program application and is required to enter permission details using an interface 103. The system assesses the user's permission details 105 and either allows the user access 109 to the requested program by validating the details 107, or denies access 111.

Permissions for users or individual groups are assessed based on the principle of explicit access or explicit denial. If an interface item is not mentioned in a permission requirement, the user has access to it. A user can be a member of zero or more groups as well as having an individual direct set of permissions that may override any group permissions that the user is a member of.

If a user is a member of two or more groups, then the permissions are assigned based on a group hierarchy. The level of the group defined in the hierarchy may determine the user's overall permission set. Therefore, an individual user's permissions may be calculated firstly by the overall group permission that the user is assigned. Then the user's direct set of permissions are considered in relation to the group permissions to achieve a final set of permissions for the individual user.

This set of permissions is now required to be applied to an application program environment to allow the user access to items such as menus and tool bars. A known method to achieve this is to apply additional user interface libraries which allow menus and toolbars to be saved and applied to the user interface of the application program. Each library must be correctly formatted to be able to insert the permission set into the user interface. Evaluating the format of each library is a time consuming task and requires additional programming to match the configuration of the user interface of the application program environment. Due to these format requirements, the permissions can only be applied to each function one at a time. A final permission set cannot be applied to the overall application program—and each subsequent function—with this library method, due to format and configuration restrictions.

FIG. 2 shows a block diagram of an embodiment of a method of that overcome the formatting concerns of previous methods.

As discussed above, an application program environment 201 may have many menus and toolbars 203 that require a user to have a certain level of permission in order to access that particular function. In a preferred embodiment, the system interrogates/parses 205 the entire application program to at least determine a description of which functions require the input of a user's permission and the format of the input 207.

The interrogation results in an XML (Extensible Markup Language) document 209 being produced that describes the minimum information required for access to the functions of the application program. The description may include requirements such as formatting, and/or configuration as discussed above.

XML is used for simplicity and gives a consistent data format for use throughout an application. It should be noted, however, that any data structure may be used to allow for native transformations and serialization/de-serialization of the document.

The XML document is used to create a schema 211 of the program structure. The XML schema 211 represents the interrelationship between the attributes and elements of the XML document 209. The programmatic representation 211 defines classes relating to such things as menus and toolbars of the application program environment. For example, when a menu is discovered in the document, an item is created in the class structure. For each function in the menu, a child/dependant item is created in the class structure.

Additionally, this process may relate to toolbars; where an item is created in the class structure for each toolbar discovered in the document, and a child item is created for each tool on the toolbar.

Preferably, the schema language used is XSD (XML Schema Definition), however other types of schema languages such as DTD (Document Type Definition) or SOX (Simple Object XML) may also be used.

The user's allowability to the available functions is determined by fetching the relevant group and user permissions, calculating the user's final permission set based on the retrieved permissions 213 and applying it 215 to the entire application program as defined in the schema 211. Depending on the user's permission, independent functions 203 of the application program are turned on/off (visible/invisible) as appropriate.

The user's final permission set may be obtained by requesting the user to enter their user name and password. A user interface (not shown) would prompt the user to enter their details, and the system would apply the permissions according to the input.

The user's allowability to the application program environment may be achieved by creating a proxy application program to substitute for the real application program. Once the proxy application is executed, the system of the present embodiment refers to the database to retrieve the user's application permissions. If specified in the user's permissions, the user may be required to enter a password before being allowed access to the real application. Once the real application is launched the user's interface permissions are applied on every new document or each open existing document request.

The current embodiment is not limited to determining access for users to certain functions; it may also be used to create themes. That is, to manipulate the user interface of the application program for convenience or style of work. The user interface can be divided into multiple zones for repositioning certain functions and, depending on the user's permission, the system may allow a user to configure the interface. Once a theme is established, it may be saved in a database, and implemented each time the user accesses the application program. All functions are initially turned off when applying themes, and are turned on by virtue of the permission comparison with the schema as discussed above.

When a user has confirmed access to a particular application or function in the application program environment, a license meter may be activated. The particular application or function requested may be governed by a limited number of licenses available, and the licence meter can keep track of users, or the availability of the function. Additionally, this feature may be used to gauge the use of a particular license and determine if there are any redundant licenses relating to the particular function.

By way of example, the current embodiment will now be described in use with ArcMap—a geographical information mapping application (see http://www.esri.com/software/arcgis/arcview/index.html).

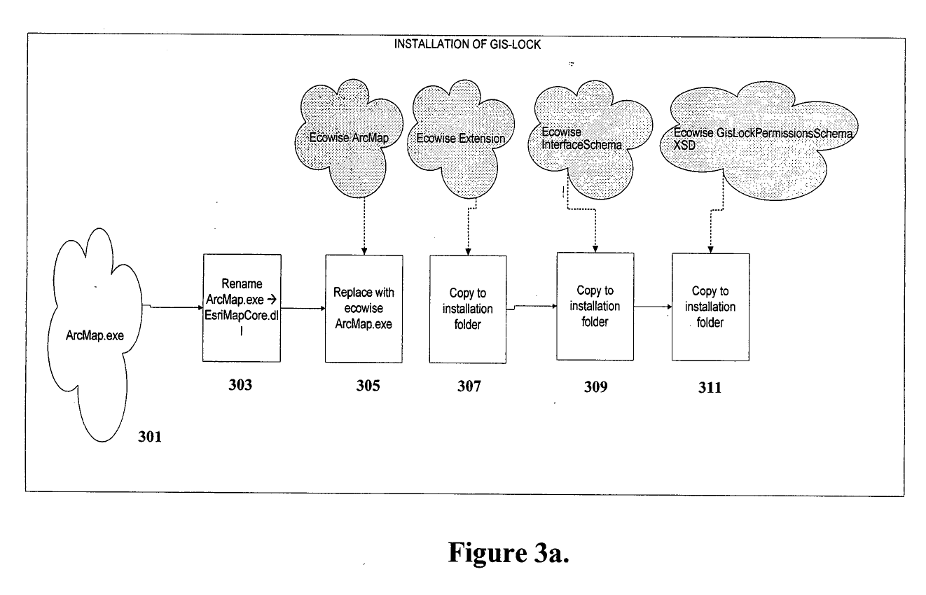

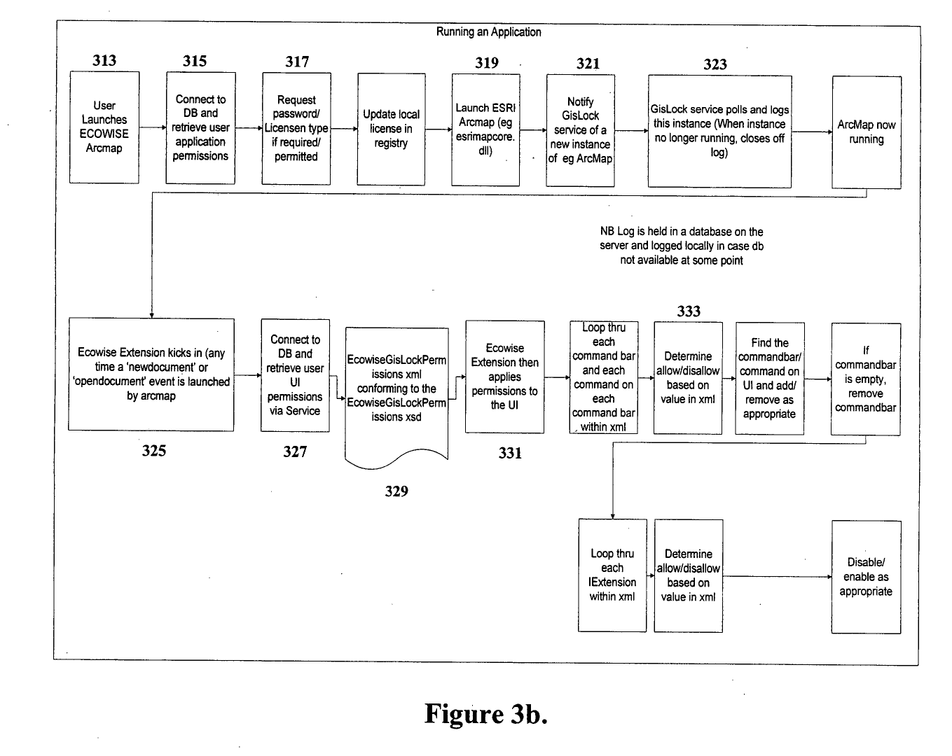

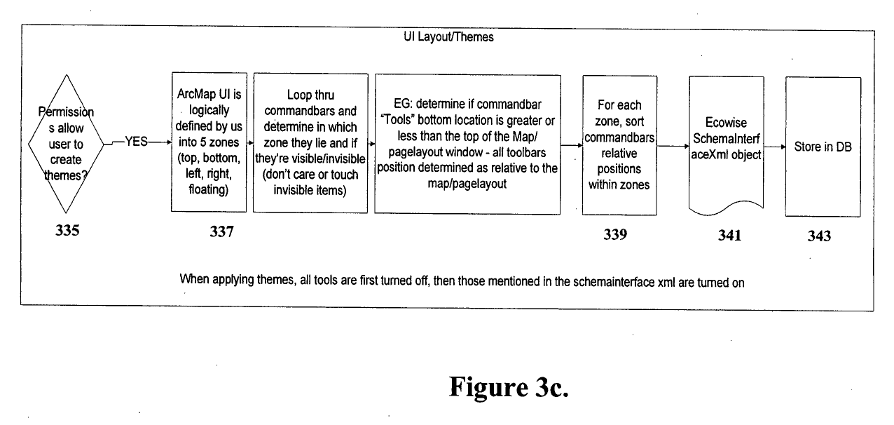

Referring to FIG. 3A, the system of the current embodiment—named GIS-Lock in this instance—is shown being installed with the ArcMap application 301. The original application is copied and renamed 303, and replaced with a proxy application 305.

The system parses the entire application program to produce a XML document 307 describing the minimum information required for user permissions. The formatting requirements are then established 309 for each interface in the application. Finally, the overall schema is produced 311 defining the class structure of the application.

FIG. 3B shows the system of the current embodiment when run with an application program. The system runs the proxy application 313 to connect to the database and retrieve user permissions 315. If any license details are required 317, they are entered at this stage before the real application is launched 319.

Once a new instance of the application program is detected, GIS-Lock is notified 321 and reports/logs an administrative poll 323. When the user opens a new document using a function in the application program 325, GIS-Lock accesses the user permissions database 327 and performs the comparison with the defined schema 329. The permissions can then be applied to the user interface 331 to allow GIS-Lock to trawl through the entire application and determine the user's allowability 333 to the functions of the program.

FIG. 3C depicts a block diagram of the GIS-Lock system with regard to a user creating themes. The permissions are determined 335 in the same manner as that described above. After defining the ArcMap user interface into 5 zones 337 and repositioning the functions according to the user's requirements 339, the schema is updated 341 and stored in a database 343.

It is to be understood that the above embodiments have been provided only by way of exemplification of this invention, and that further modifications and improvements thereto, as would be apparent to persons skilled in the relevant art, are deemed to fall within the broad scope and ambit of the current invention described and claimed herein.

What is claimed is:

1. A method for determining user access to an application program environment comprising:
(a) parsing the entire application program to determine a description of user permission requirements;
(b) providing a document containing the description of user permission requirements based on the parsing;
(c) producing a schema that models a class structure of the description of user permission requirements based on the document; and
(d) determining user access based on a comparison of a predetermined user's permission and the permission requirements in the class structure.

2. The method of claim 1 wherein the document is a XML document, and the schema is a XML schema.

3. The method of claim 2 wherein the predetermined user's permission is a group permission.

4. The method of claim 2 wherein the predetermined user's permission is a combination of a group permission and an individual user's permission.

5. The method of claim 2 wherein the class structure comprises items of menus and toolbars.

6. A method for applying user permissions to an application program environment comprising:
(a) parsing the entire application program to determine a description of user permission requirements;
(b) providing a document containing the description of user permission requirements based on the parsing of the program application;
(c) producing a schema that models a class structure of the description of user permission requirements based on the document;
(d) creating a proxy application that is called prior to launching the application program environment;
(e) retrieving a user's predetermined permission set;
(f) applying the user's predetermined permission set to the schema to produce a user's permission schema;
(g) launching the application program environment;
(h) applying the user's permissions by loading the user's permission schema in to the application program environment.

7. The method of claim 6 wherein the document is a XML document, and the schema is a XML schema.

8. A system comprising logic stored on a computer readable medium, operable to:
(a) parse the entire application program to determine a description of user permission requirements;
(b) provide a document containing the description of user permission requirements based on the parsing;
(c) produce a schema that models a class structure of the description of user permission requirements based on the document; and
(d) determine user access based on a comparison of a predetermined user's permission and the permission requirements in the class structure.

9. The system of claim 8 wherein the document is a XML document, and the schema is a XML schema.

10. The system of claim 9 wherein the predetermined user's permission is a group permission.

11. The system of claim 9 wherein the predetermined user's permission is a combination of a group permission and an individual user's permission.

12. The system of claim 9 wherein the class structure comprises items of menus and toolbars.

13. A system comprising logic stored on a computer readable medium, operable to:
(a) parse the entire application program to determine a description of user permission requirements;
(b) provide a document containing the description of user permission requirements based on the parsing of the program application;
(c) produce a schema that models a class structure of the description of user permission requirements based on the document;
(d) create a proxy application that is called prior to launching the application program environment;
(e) retrieve a user's predetermined permission set;
(f) apply the user's predetermined permission set to the schema to produce a user's permission schema;
(g) launch the application program environment;
(h) apply the user's permissions by loading the user's permission schema in to the application program environment.

14. The system of claim 13 wherein the document is a XML document, and the schema is a XML schema.
